(19) United States
(12) Patent Application Publication
(10) Pub. No.: US 2008/0285075 A1
(43) Pub. Date: Nov. 20, 2008

(54) WORKFLOW GENERATING APPARATUS AND WORKFLOW GENERATING METHOD

(75) Inventor: Kazunari Yamanakajima, Kawasaki-shi (JP)

Correspondence Address: CANON U.S.A. INC. INTELLECTUAL PROPERTY DIVISION, 15975 ALTON PARKWAY, IRVINE, CA, 92618-3731, US

(73) Assignee: CANON KABUSHIKI KAISHA, Tokyo (JP)

(21) Appl. No.: 12/119,135

(22) Filed: May 12, 2008

(30) Foreign Application Priority Data
May 14, 2007 (JP) 2007-128165

(51) Int. Cl. G06F 3/12

(52) U.S. Cl. 358/1.15

(57) ABSTRACT

In generating a combined workflow, processing steps that are included in different workflows and that use the same function are integrated into a single step. At this time, if it is determined that there exists any difference among properties for the processing steps, a processing step for adjustment relating to the difference is specified as needed.

### BACKGROUND OF THE INVENTION

1. Field of the Invention

The present invention relates to techniques for generating a combined workflow by combining a plurality of workflows.

2. Description of the Related Art

With the development of information technology, the functions of image forming apparatuses, such as copying machines, have become complex, and image forming apparatuses have evolved into multifunction peripherals (MFPs), in which various functions are integrated. The MFPs now have even more advanced functions, such as a function for editing an image on the MFPs or a function for executing processing in cooperation with an external service or the like.

Furthermore, for the purpose of improving work efficiency in office environments, an apparatus has been developed in which a plurality of functions of an MFP can be combined and defined as a workflow so that the defined workflow can be executed.

Furthermore, as an example of a method of constructing and executing a process, according to Japanese Patent Laid-Open No. 2005-32211, a process is divided into steps, and each of the steps is classified as either a determining step or a working step according to whether a determination is needed in the step. If a step can be executed using a condition set in a determining step, the step is arranged to follow the determining step. A series of combined steps is defined as a single process, and a parallel workflow is constructed. Accordingly, the workflow can be executed efficiently.

According to the related art described above, however, it is only possible to simply execute a workflow as it is defined. Thus, when a plurality of workflows including the same step are executed, the same step must be executed a plurality of times. This has been a user's burden. Now, examples of issues addressed in this specification will be described. As an example, a case will be considered where a workflow 1 in which a printed copy of a document A composed of 100 pages is scanned and copied and a workflow 2 in which the printed copy of the same document A composed of 100 pages is scanned and corresponding data is sent to another device are to be executed. When the workflow 1 and the workflow 2 are both executed, a step of scanning the 100 pages of the printed copy of the document A is executed twice. Thus, as a first issue to be addressed, the efficiency of processing could be reduced by executing the same processing step a plurality of times.

Although it may be possible with some techniques to combine processing steps that are included in a plurality of workflows and that use the same function in order to improve the efficiency of processing, in some cases, it is not possible to simply combine steps. For example, when the scanning steps of the workflow 1 and the workflow 2 are to be combined, if there exists a difference between scanning properties of the workflows 1 and 2, results of processing desired by the user are not necessarily obtained successfully if these workflows are simply combined. Thus, as a second issue to be addressed, results of processing that are to be obtained by individual workflows before combining are not necessarily obtained successfully through a combined workflow.

### SUMMARY OF THE INVENTION

According to the present invention, user's convenience is improved, and it becomes possible through a combined workflow to obtain results of processing that are to be obtained through individual workflows before combining.

According to the present invention, a workflow in which processing steps that use the same function are integrated into a single step is generated. At that time, if it is determined that there exists any difference between the processing steps, a processing step for adjustment relating to the difference is specified as needed.

According to an aspect of the present invention, a workflow generating apparatus includes an analyzing unit configured to analyze properties of a plurality of processing steps that are included in a plurality of workflows and that use the same function; a combining unit configured to combine the plurality of processing steps to generate a combined processing step; a specifying unit configured to specify an adjustment processing step if it is determined by the analyzing unit that there exists any difference between the properties of the plurality of processing steps, the adjustment processing step being a processing step for adjustment relating to the difference; and a joining unit configured to join the plurality of workflows using the combined processing step and the adjustment processing step, thereby generating a combined workflow.

According to another aspect of the present invention, a workflow generating apparatus for generating a workflow in which a plurality of processing steps are executed sequentially includes a selecting unit configured to select a plurality of workflows; a determining unit configured to determine processing steps that use the same function in the plurality of workflows selected by the selecting unit; and a generating unit configured to generate a workflow in which the processing steps that use the same function, determined by the determining unit, are integrated into a single processing step.

Other features and aspects of the present invention will be apparent from the following description taken in conjunction with the accompanying drawings, in which like reference characters designate the same or similar parts throughout the figures thereof.

### BRIEF DESCRIPTION OF THE DRAWINGS

The accompanying drawings, which are incorporated in and constitute a part of the specification, illustrate embodiments of the invention and, together with the description, serve to explain the principles of the invention.

FIG. 1 is a block diagram showing an example configuration of a network system including an image forming apparatus according to an embodiment of the present invention.

FIG. 2 is a block diagram showing an example configuration of MFPs shown in FIG. 1.

FIG. 3 is a block diagram showing an example configuration of a server PC and a client PC shown in FIG. 1.

FIG. 4 is an illustration for explaining an operating unit of an MFP.

FIG. 5 is a functional block diagram relating to a workflow combining process.

FIG. 6 is a diagram showing two workflows including steps that use the same function.

FIG. 7 is a diagram showing setting information for printing steps shown in FIG. 6.

FIG. 8 is a diagram showing a combined workflow generated by combining two workflows shown in FIG. 6.

FIG. 9 is an illustration showing an operation user interface for generating a combined workflow by combining two workflows and executing the combined workflow.

FIG. 10 is a diagram showing two workflows including steps that use the same function but that use different settings.

FIG. 11 is a diagram showing setting information for scanning steps in the workflows shown in FIG. 10.

FIG. 12 is a diagram showing a combined workflow generated by combining the two workflows shown in FIG. 10.

FIG. 13 is a diagram showing setting information for scanning steps in the workflows shown in FIG. 10.

FIG. 14 is a diagram showing a combined workflow generated by combining the two workflows shown in FIG. 10 using setting values shown in FIG. 13.

FIG. 15 is a flowchart of a workflow combining process.

FIG. 16 is a flowchart showing details of step S1504 in FIG. 15.

FIG. 17 is a diagram showing determining criterion information used to determine whether combining is allowed in a process according to the flowchart shown in FIG. 16.

FIG. 18 is a diagram showing a table of information use to determine qualities in combining methods shown in FIG. 17.

### DESCRIPTION OF THE EMBODIMENTS

Embodiments of the present invention will now be described in detail in accordance with the accompanying drawings.

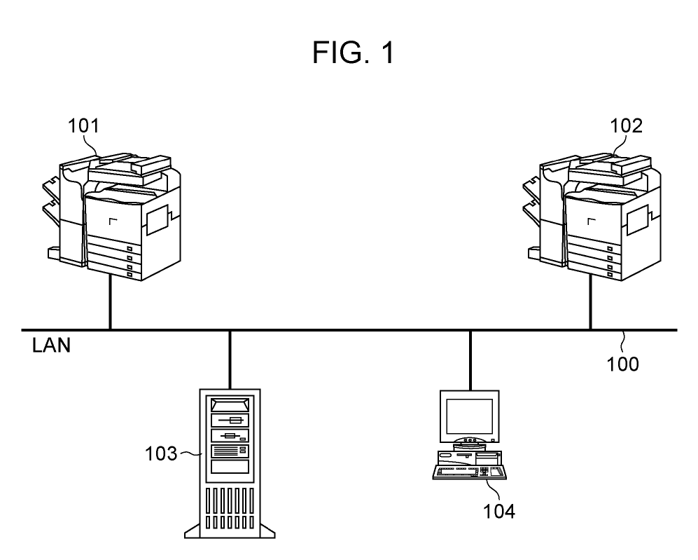

FIG. 1 is a diagram showing an example configuration of a network system including an image forming apparatus according to an embodiment of the present invention. The image forming apparatus according to this embodiment is an MFP having a data sending and receiving function. The MFP is configured so that it constitutes an example of a combined-workflow generating apparatus according to the present invention. In this specification, information defining a plurality of processing steps that are to be executed sequentially is referred to as a workflow.

Referring to FIG. 1, the network system includes a local area network (LAN) 100, MFPs 101 and 102, a server personal computer (server PC) 103, and a client personal computer (client PC) 104.

The MFP 101 has a copying function, and also has a data sending function for scanning an original document image and sending corresponding data to devices on the LAN 100. Furthermore, the MFP 101 has a page description language (PDL) function, so that the MFP 101 can receive a PDL image instructed by a computer connected on the LAN 100 and print the PDL image.

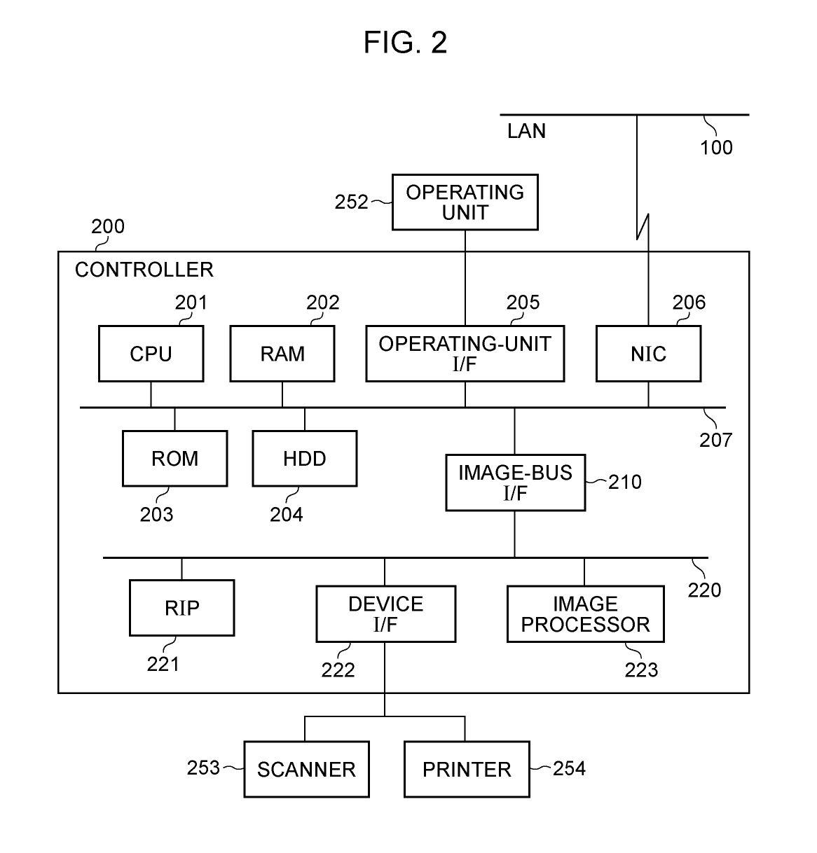

The MFP 101 can save an image scanned by the MFP 101 or a PDL image instructed by a computer connected on the LAN 100, in a hard disk drive (HDD) 204 (shown in FIG. 2) of the MFP 101. Furthermore, the MFP 101 can print the image saved in the HDD 204.

The MFP 101 can receive via the LAN 100 data scanned by the MFP 102, and save the received data in the HDD 204 (shown in FIG. 2) of the MFP 101 or to print and output a corresponding image. Furthermore, the MFP 101 can receive an image from the server PC 103 or the client PC 104 and save the image in the MFP 101 or print and output the image. The MFP 102 also has functions similar to the functions of the MFP 101.

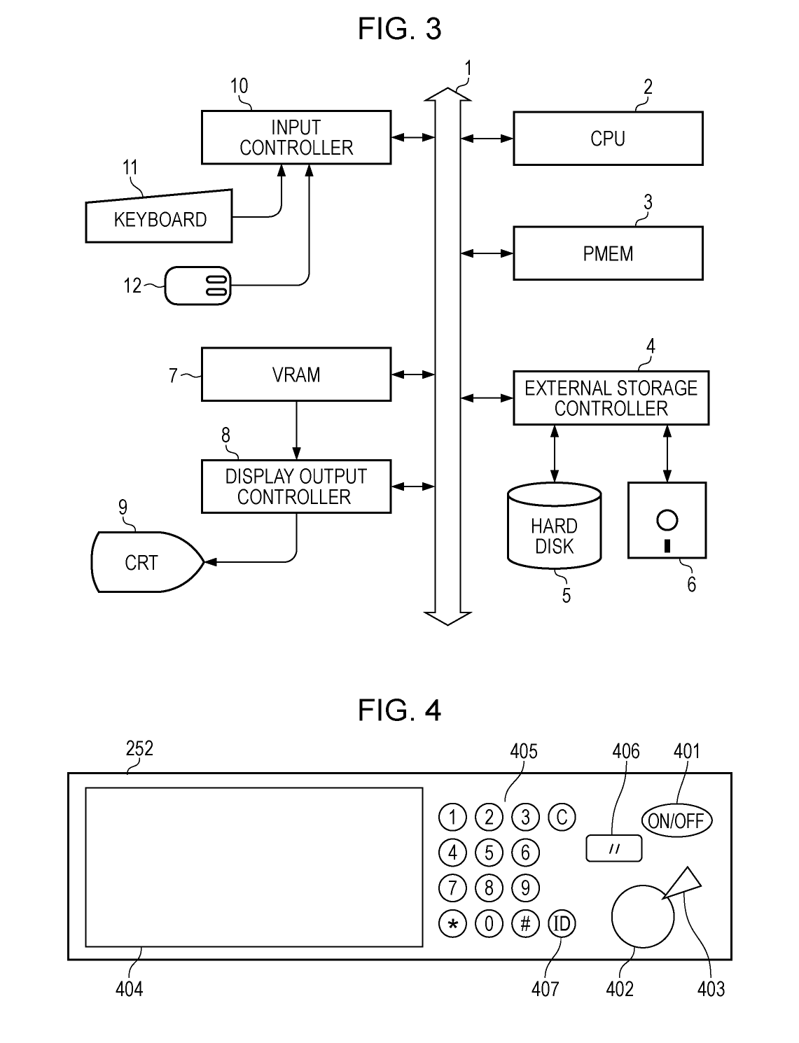

The server PC 103 collects information regarding the operation statuses of the MFP 101 and the MFP 102 via the LAN 100, and stores the information in a database for management. Furthermore, the server PC 103 can receive via the LAN 100 data scanned by the MFP 101 or the MFP 102, and save the received data in a hard disk 5 (shown in FIG. 3) of the server PC 103.

The client PC 104 can obtain desired data from the server PC 103 and display a corresponding image. Furthermore, the client PC 104 can receive via the LAN 100 data scanned by the MFP 101 or the MFP 102, and process or edit the received data.

FIG. 2 is a block diagram showing an example configuration of the MFPs 101 and 102 shown in FIG. 1. A controller 200 controls input and output of document data, image information, and device information. The controller 200 is connected to a scanner 253, which functions as an image input device, and to a printer 254, which functions as an image output device, so that a scanning function, a printing function, and so forth are implemented. Furthermore, the controller 200 is connected to the LAN 100 via a network interface card (NIC) 206 so that data can be exchanged with external apparatuses such as other MFPs or PCs.

The controller 200 includes a central processing unit (CPU) 201, a random access memory (RAM) 202, a read-only memory (ROM) 203, and an HDD 204. The RAM 202 is used as a work memory for the operation of the CPU 201 and as an image memory for temporarily storing image data. The ROM 203 stores a boot program for the system. The HDD 204 stores system software, image data and property data thereof, user data, data relating to workflows described later, and so forth.

An operating unit 252 is a user interface for using the scanning function, the printing function, and so forth. An operating-unit interface (I/F) 205 outputs data of an image that is to be displayed on the operating unit 252. Furthermore, the operating-unit I/F 205 transmits information input by a user via the operating unit 252 to the CPU 201.

An image-bus I/F 210 is a bus bridge that connects a system bus 207 with an image bus 220 that transfers image data at a high speed and that execute conversion of data structure.

On the image bus 220, a raster image processor (RIP) 221, a device I/F 222, and an image processor 223 are provided. The RIP 221 renders PDL code input from an information processing apparatus on the LAN 100 into a bitmap image. The device I/F 222 connects the scanner 253, which functions as an image input device, and the printer 254, which functions as an image output device, to the controller 200, and executes conversion of image data between synchronous/asynchronous systems. The image processor 223 corrects, processes, or edits input image data.

FIG. 3 is a block diagram showing an example configuration of the server PC 103 and the client PC 104 shown in FIG. 1.

The components shown in FIG. 3 are connected to a system bus 1. A CPU 2 controls the other components via the system bus 1, and it executes programs according to a control program stored in a ROM (not shown). A program memory (PMEM) 3 is a memory for selecting and reading a control program for executing conditional branching from the ROM as needed. Furthermore, data input from a keyboard 11 is stored as code information in the PMEM 3, which also functions as a text memory.

An external storage controller 4 controls writing of data to and reading of data from external storage devices (a hard disk 5 and a floppy disk 6 in this embodiment). The hard disk 5 is an external storage device for storing data files. The floppy disk 6 is also an external storage device for storing data files.

An input controller 10 is connected to input devices, such as a keyboard 11 and a pointing device 12. An operator issues an operation instruction or the like to the system by operating the keyboard 11. The pointing device 12 is used when the operator instructs processing of image information on a cathode-ray tube (CRT) display 9. Using the pointing device 12, the operator can move a cursor on the CRT display 9 as desired in X and Y directions to select a command icon on a command menu to issue an instruction for processing, and also issue an instruction of an item to be edited, an instruction of a drawing position, and so forth.

A video image memory (VRAM) 7 is a memory in which text data or graphic data of information to be displayed on the CRT display 9 is rendered into bitmap data. A display output controller 8 controls display on the CRT display 9. Without limitation to the CRT 9, other types of display may be used, such as a liquid crystal monitor.

FIG. 4 is an illustration showing the configuration of the operating units 252 of the MFPs 101 and 102. A power button 401 is a button used to power on or power off the MFP. A start button 402 is used to execute a scanning process, a printing process, and so forth. A cancel button 403 is used to cancel a process started using the start button 402, in the course of its execution. A display 404 is a liquid crystal display (LCD) for displaying operation dialogs, buttons, and so forth formed of images and programs sent via the operating-unit I/F 205. Furthermore, a touch panel is provided on the LCD so that the user can operate the operation dialogs or press the buttons displayed on the display 404. A numeric keypad 405 is a set of buttons for inputting the number of copies to print or other values and clearing input values. A reset button 406 is used to initialize information set via the operating unit 252. An ID button 407 is used for user authentication.

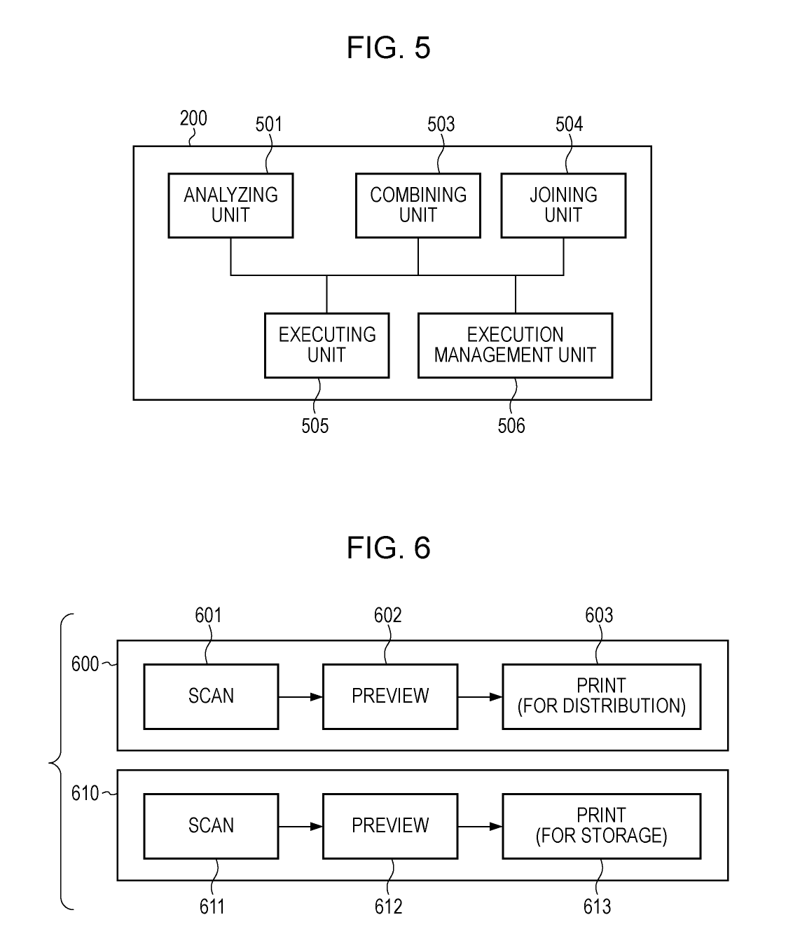

FIG. 5 is a functional block diagram regarding a workflow combining process. The execution of a workflow and combining of workflows occur within the controller 200.

An analyzing unit 501 is a block that analyzes individual steps of workflows and that determines whether combining is allowed based on the results of analysis. A combining unit 503 is a block that combines steps based on the results of analysis by the analyzing unit 501. A joining unit 504 is a block that generates a combined workflow by joining a plurality of original workflows, using a combined step generated by the combining unit 503. An executing unit 505 is a block that executes the combined workflow. An execution management unit 506 is a block that acts as an upper-level unit to manage the workflow being executed by the executing unit 505. For example, upon occurrence of an error in a step in the combined workflow, the execution management unit 506 compares the step with the original workflows, and if the step affects only either one of the workflows, the execution management unit 506 executes processing so that the other workflow is continued. The joining unit 504 is configured so that it constitutes an example of a joining unit as a feature of the present invention. For example, in a combined workflow 1200 shown in FIG. 12, if an error occurs in a printing step 1003 of the combined workflow 1200, the error in the printing step 1003 does not affect steps from image adjustment (monochrome) 1203 to sending 1013. Thus, even if an error occurs in the printing step 1003, the steps from image adjustment (monochrome) 1203 to sending 1013 in the combined workflow 1200 are continued. The executing unit 505 is configured so that it constitutes an example of an executing unit as a feature of the present invention.

Furthermore, some workflows have additional steps of deleting documents after execution of the workflows in order to meet security requirements. If any of the original workflows has such an additional step, the execution management unit 506 executes processing for deleting a document after execution of the workflow. Furthermore, if any of the original workflows has an additional step that is to be executed before execution of the workflow, the execution management unit 506 executes the additional step before execution of the combined workflow. That is, if there exists any additional step that is to be executed before or after execution of original workflows, the execution management unit 506 performs a control operation so that the additional step is executed before or after execution of the combined workflow. The processing executed by the execution management unit 506 is an example of processing executed by an execution management unit as a feature of the present invention.

FIG. 6 is a diagram showing two workflows 600 and 610 including steps that use the function.

Scanning steps 601 and 611 are steps of creating image data by copying content represented on a sheet of paper in an image forming apparatus. Previewing steps 602 and 612 are steps of checking overviews of image data created in the scanning steps 601 and 611, respectively. The overviews of the image data are checked, for example, by displaying thumbnails of the image data on the display 404. Printing steps 603 and 613 are steps of outputting image data created in the scanning steps 601 and 611, respectively, onto a paper medium. The paper medium output in the printing step 603 is intended for distribution in a meeting or the like. On the other hand, the paper medium output in the printing step 613 is intended for storage for future reference.

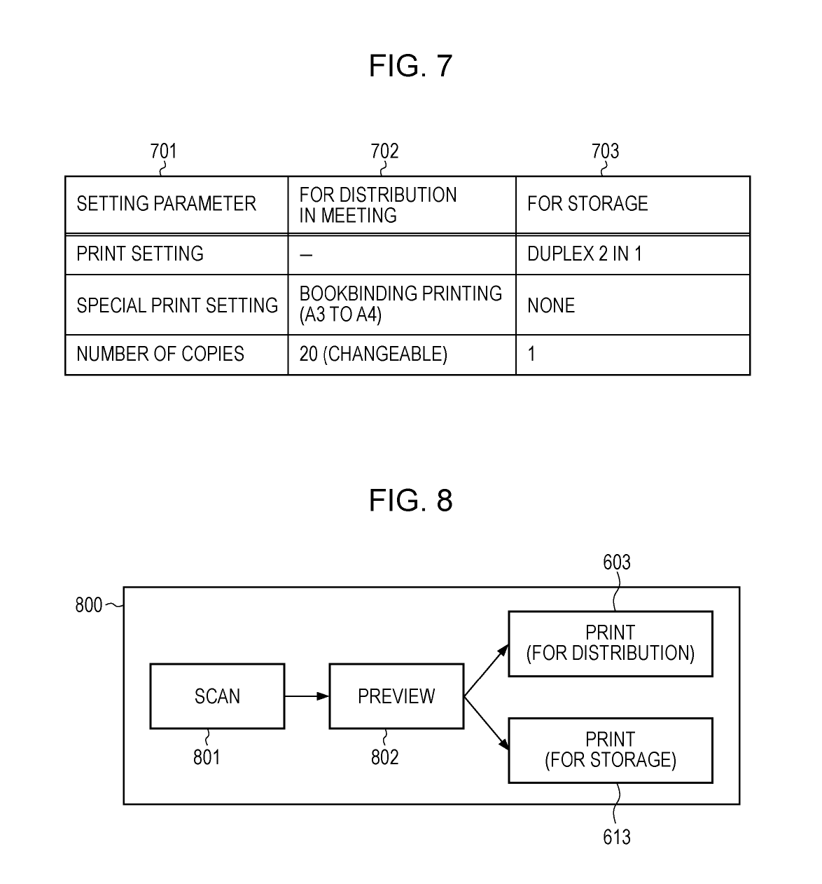

FIG. 7 is a diagram showing setting information for the printing steps 603 and 613 shown in FIG. 6. A setting parameter column 701 represents types of parameters that can be set in the printing steps 603 and 613. “Print setting” is a parameter used to set how content of image data is to be allocated on a sheet, such as simplex printing, duplex printing, or N in 1 printing for allocating a plurality of pages of content data in one page. “Special print setting” is a parameter used to set an output form of sheet medium, such as a bookbinding printing for saddle stitching sheets using a staple. “Number of copies” parameter is used to set a number of copies to be output.

A distribution-in-meeting column 702 represents detailed information for the printing step 603. Since “Special print setting” parameter specifies bookbinding printing, “Print setting” parameter is automatically invalidated. In “Number of copies” parameter, a value of 20, for example, is specified as the number of copies for distribution.

A storage column 703 represents detailed information for the printing step 613. In order to reduce the number of sheets that are to be stored, duplex 2 in 1 printing is specified. Nothing is specified in “Special print setting” parameter. In “Number of copies” parameter, a value of 1, for example, is specified as the number of copies for storage.

FIG. 8 is a diagram showing a workflow 800 generated by combining the two workflows 600 and 610 shown in FIG. 6.

A scanning step 801 is a step generated by combining the scanning steps 601 and 611. Since the scanning steps 601 and 611 are steps for the same processing with the same setting values, the scanning step 801 is a step in which the same processing is executed as in the scanning step 601 or the scanning step 611.

Similarly, since the previewing steps 602 and 612 are steps for executing the same processing, in a combined previewing step 802, the same processing is executed as in the previewing step 602 or the previewing step 612.

The printing steps 603 and 613 have different output formats, so that it is not allowed to combine these steps. In the combined workflow 800, the scanning steps 601 and 611 and the previewing steps 602 and 612 in the original workflows 600 and 610 are integrated into the common scanning step 801 and common previewing step 802. However, execution of the combined workflow 800 yields the same results as execution of both of the original workflows 600 and 610. Accordingly, efficiency is improved.

FIG. 9 is an illustration of an operation user interface used to generate the combined workflow 800 from the workflows 600 and 610 and executing the combined workflow 800. A button 901 is used to select workflows. A button 902 is used to execute workflows. When a plurality of workflows are selected and executed, a combined workflow is created and executed. That is, the analyzing unit 501 selects a plurality of workflows specified by the user.

A button 903 is used to proceed to another operation user interface. A button 904 is used to scroll a displayed list of workflows.

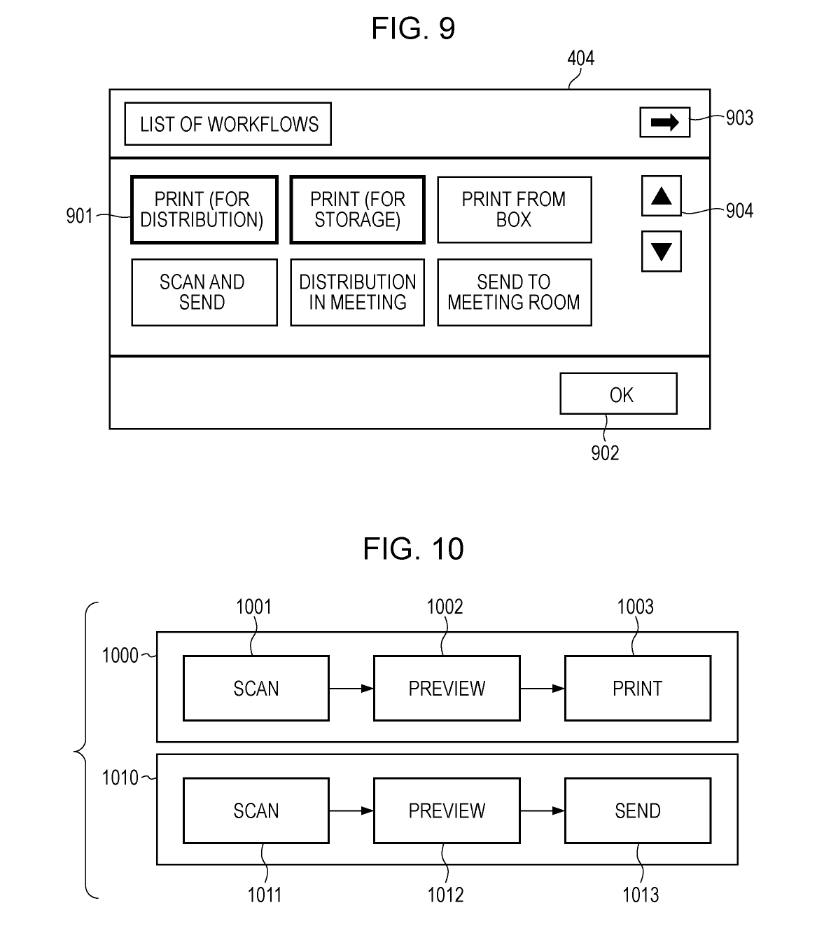

FIG. 10 is a diagram showing two workflows 1000 and 1010 including steps that use the same function but involve different settings.

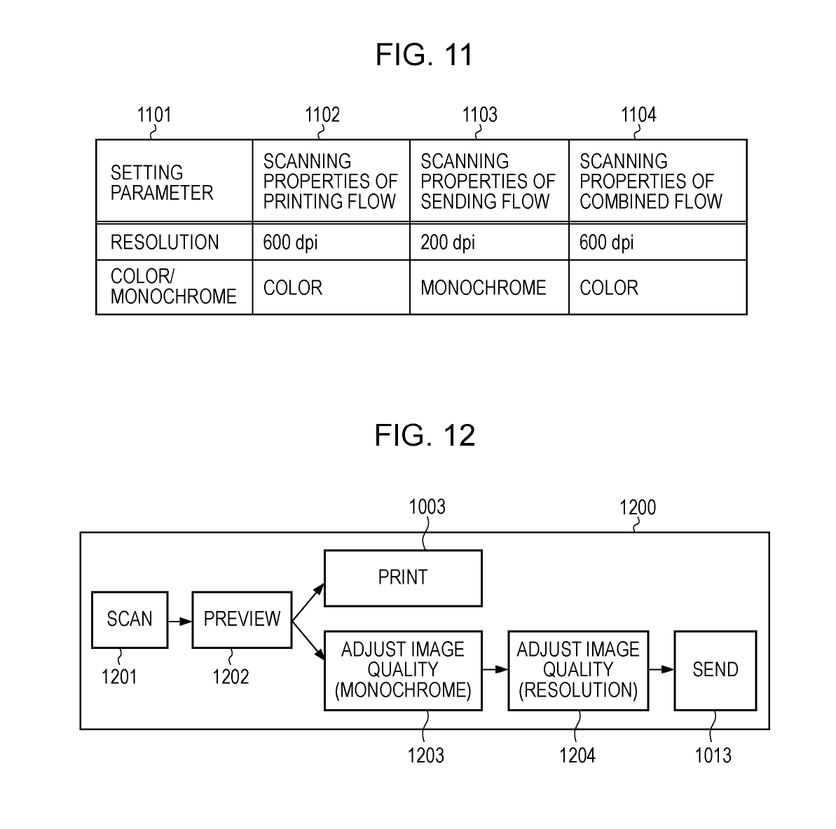

Scanning steps 1001 and 1011 are steps of copying content represented on a sheet of paper and generating corresponding image data in an image forming apparatus. However, the scanning steps 1001 and 1011 have different settings. The difference between the settings will be described later with reference to FIG. 11.

Previewing steps 1002 and 1012 are steps of checking overviews of image data created in the scanning steps 1001 and 1011, respectively. The overviews of image data are checked, for example, by displaying thumbnails of the image data on the display 404. A printing step 1003 is a step of outputting the image data created in the scanning step 1001 onto a paper medium. A sending step 1013 is a step of sending the image data created in the scanning step 1011 as an attachment to an e-mail or to another server on the network.

FIG. 11 is a diagram showing setting information for the scanning steps 1001 and 1011 in the workflows shown in FIG. 10.

A setting parameter column 1101 represents types of parameters that can be set for the scanning steps 1001 and 1011. “Resolution” parameter is used to set a resolution of image data created in the scanning steps 1001 and 1011. For example, the resolution is set in terms of dpi (dots per inch). “Color/monochrome” parameter is used to set whether image data is to be created using a plurality of color components or using a single color.

A printing-flow scanning property column 1102 represents setting values for the scanning step 1001. A sending-flow scanning property column 1103 represents setting values for the scanning step 1011. A combined-flow scanning property column 1104 represents setting values for a scanning step 1201 of a combined workflow 1200 described later with reference to FIG. 12.

In the combined-flow scanning property column 1104, of the individual setting values (resolutions and color/monochrome) in the printing-flow scanning property column 1102 and the sending-flow scanning property column 1103, setting values with higher qualities are selected.

FIG. 12 is a diagram showing a workflow 1200 generated by combining the two workflows 1000 and 1010 shown in FIG. 10.

A scanning step 1201 is a step generated by combining the scanning steps 1001 and 1011. As described above, the scanning step 1201 has setting values corresponding to setting values with higher qualities among the individual setting values for the scanning steps 1001 and 1011. Thus, in the scanning step 1201, scanning is executed at a resolution of 600 dpi.

Since the previewing steps 1002 and 1012 are steps that use the same function, a combined previewing step 1202 is generated so that the same processing is executed as in the previewing step 1002 or the previewing step 1012.

The printing step 1003 is a printing step of the workflow 1000. In the printing step 1003, image data created in color with a resolution of 600 dpi is output onto a paper medium.

Image adjusting steps 1203 and 1204 are steps added to the combined workflow 1200 in accordance with combining of the workflows 1000 and 1010. Although image data is created in color with a resolution of 600 dpi in the scanning step 1201, in the sending step 1013, monochrome image data with a resolution of 200 dpi is to be sent. Thus, in the image adjusting step 1203, software provided in the controller automatically converts a color image into a monochrome image. Furthermore, in the image adjusting step 1204, the software provided in the controller 200 automatically converts the resolution from 600 dpi to 200 dpi.

Since the image adjusting steps 1203 and 1204 are executed automatically, the user executing the workflow need not perform any task.

In the workflow 1200, the scanning steps 1001 and 1011 and the previewing steps 1002 and 1012 in the original workflows 1000 and 1010 are integrated into the common scanning step 1201 and previewing step 1202. However, the execution of the workflow 1200 yields substantially the same results as the execution of both of the original workflows 1000 and 1010. Accordingly, efficiency is improved.

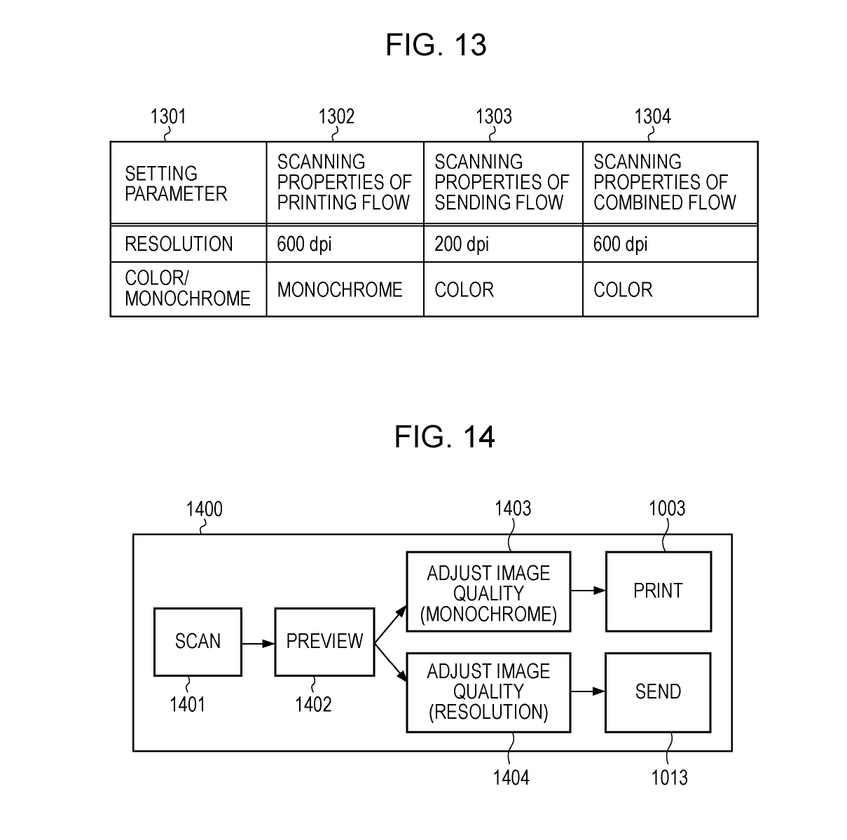

FIG. 13 is a diagram showing setting information for the scanning steps 1001 and 1011 in the workflows 1000 and 1010 shown in FIG. 10. The values of the setting information in FIG. 13 differ from those in FIG. 11.

A setting parameter column 1301 represents types of parameters that can be set for the scanning steps 1001 and 1011, and the values in the setting parameter column 1301 are the same as those in FIG. 11.

A printing-flow scanning property column 1302 represents setting values for the scanning step 1001. A sending-flow scanning property column 1303 represents setting values for the scanning step 1011. A combined-flow scanning property column 1304 represents setting values for a scanning step 1401 of a combined workflow 1400 described later with reference to FIG. 14.

In the combined-flow scanning property column 1304, setting values with higher qualities are selected among the individual setting values in the printing-flow scanning property column 1302 and the sending-flow scanning property column 1303.

FIG. 14 is a diagram showing a combined workflow 1400 generated by combining the two workflows 1000 and 1010 shown in FIG. 10 using the setting values shown in FIG. 13.

A scanning step 1401 is a step generated by combining the scanning steps 1001 and 1011. The scanning step 1401 has setting values with higher qualities among the individual setting values of the scanning steps 1001 and 1011. Thus, in the scanning step 140, scanning is executed in color at a resolution of 600 dpi.

A previewing step 1402, generated by combining the previewing steps 1002 and 1012, is a step in which the same processing is executed as in the scanning step 1002 or the scanning step 1012.

Image adjusting steps 1403 and 1404 are steps added in accordance with the combining of the workflows 1000 and 1010.

Although image data is created in color at a resolution of 600 dpi in the scanning step 1401, it is necessary to print monochrome image data at a resolution of 600 dpi in the printing step 1003. Thus, in the image adjusting step 1403, the software provided in the controller 200 automatically converts a color image into a monochrome image.

Furthermore, in the sending step 1013, it is necessary to send color image data at a resolution of 200 dpi. Thus, in the image adjusting step 1404, the software provided in the controller 200 automatically converts the resolution from 600 dpi to 200 dpi.

Since the image adjusting steps 1403 and 1404 are executed automatically, the user executing the workflow need not execute any task.

Although the scanning steps 1001 and 1011 and previewing steps 1002 and 1012 in the original workflows 1000 and 1010 are integrated into the common scanning step 1401 and previewing step 1402 in the combined workflow 1400, execution of the combined workflow 1400 yields substantially the same results as execution of both of the original workflows 1000 and 1010. Accordingly, efficiency is improved.

Furthermore, in the combined workflow 1400, the image adjusting steps 1403 and 1404 are added for the individual workflows, so that original image data acquired in the scanning step 1401 is not used. It is possible to refrain from combining workflows in such a case where an original image is not used.

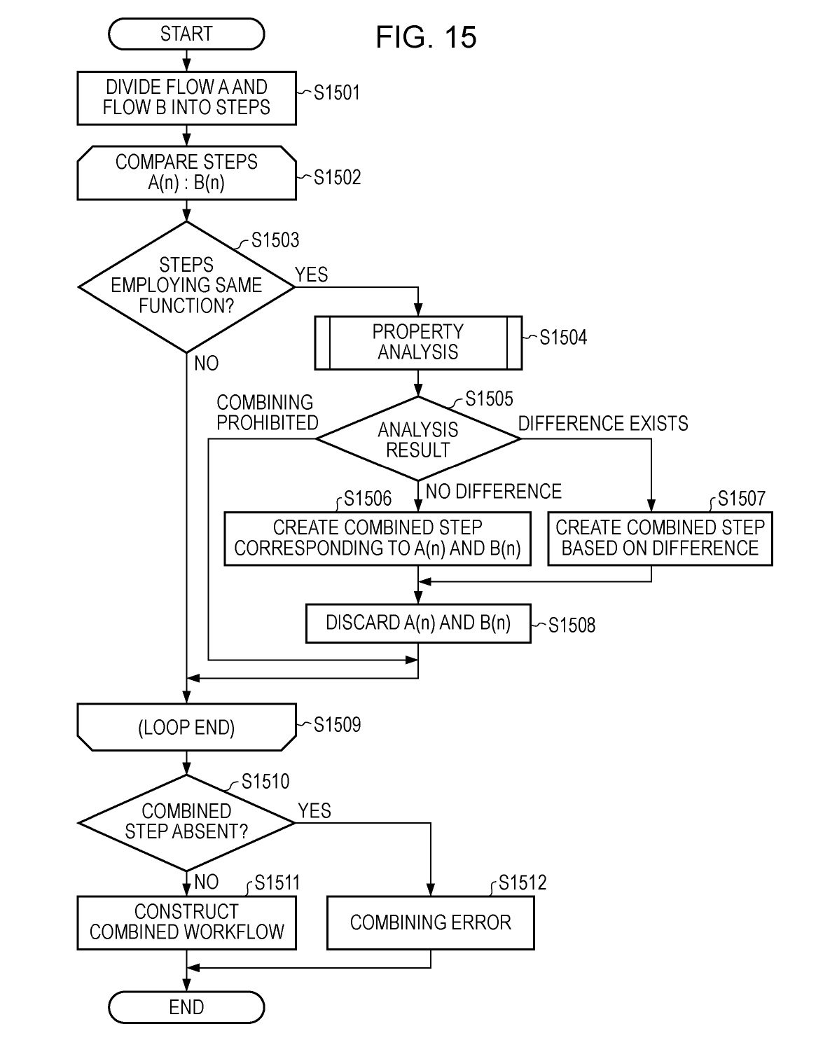

FIG. 15 is a flowchart showing an example of a workflow combining process. In the example shown in FIG. 15, two workflows are combined.

First, the analyzing unit 501 divides two specified workflows A and B into steps (processing steps) (S1501), compares the steps with each other (S1502), and executes searching to determine whether steps that use the same function exist (S1503). More specifically, for example, if the first processing step in the flow A is a scanning step, the analyzing unit 501 determines whether a scanning step exists in the flow B. Step S1503 is an example of processing executed by a determining unit as a feature of the present invention. Furthermore, processing for specifying the two workflows A and B is an example of processing executed by a selecting unit as a feature of the present invention.

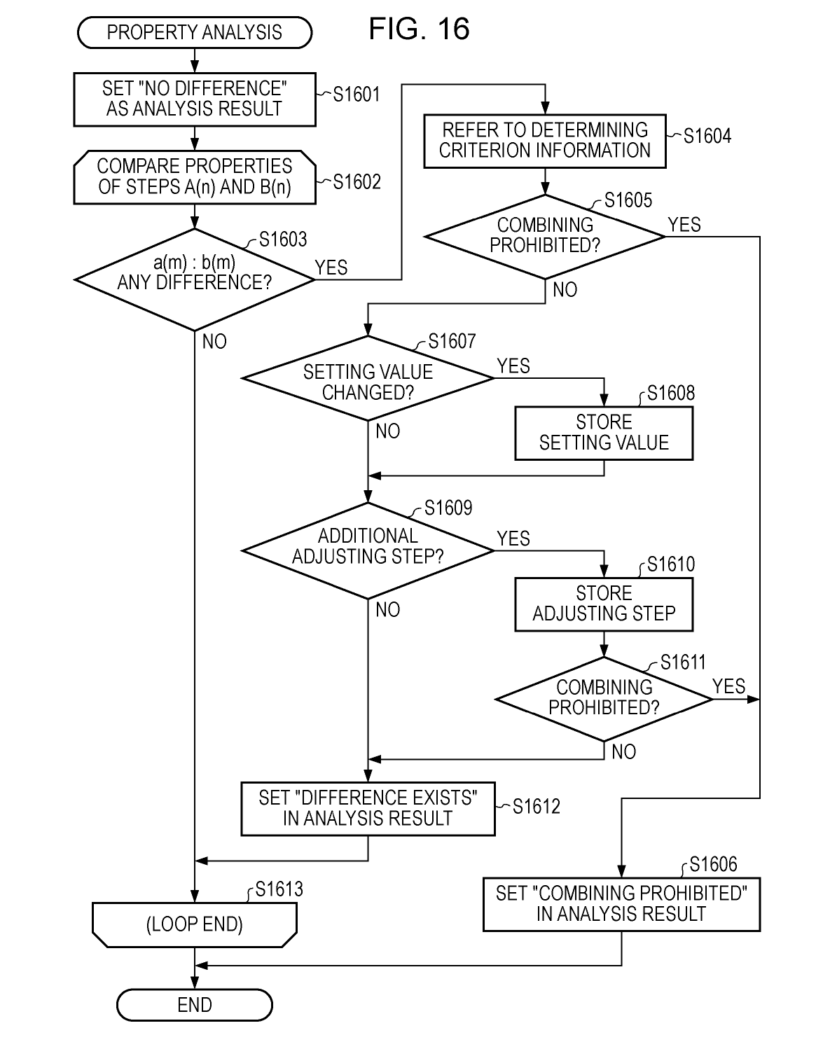

If steps that use the same function are found, the analyzing unit 501 analyzes matching between properties for the steps (S1504). Step S1504 will be described later in detail with reference to FIG. 16. The analyzing unit 501 classifies the matching as one of three types, namely, “combining prohibited”, “no difference”, and “difference exists” (S1505). Step S1504 is an example of processing executed by an analyzing unit as a feature of the present invention.

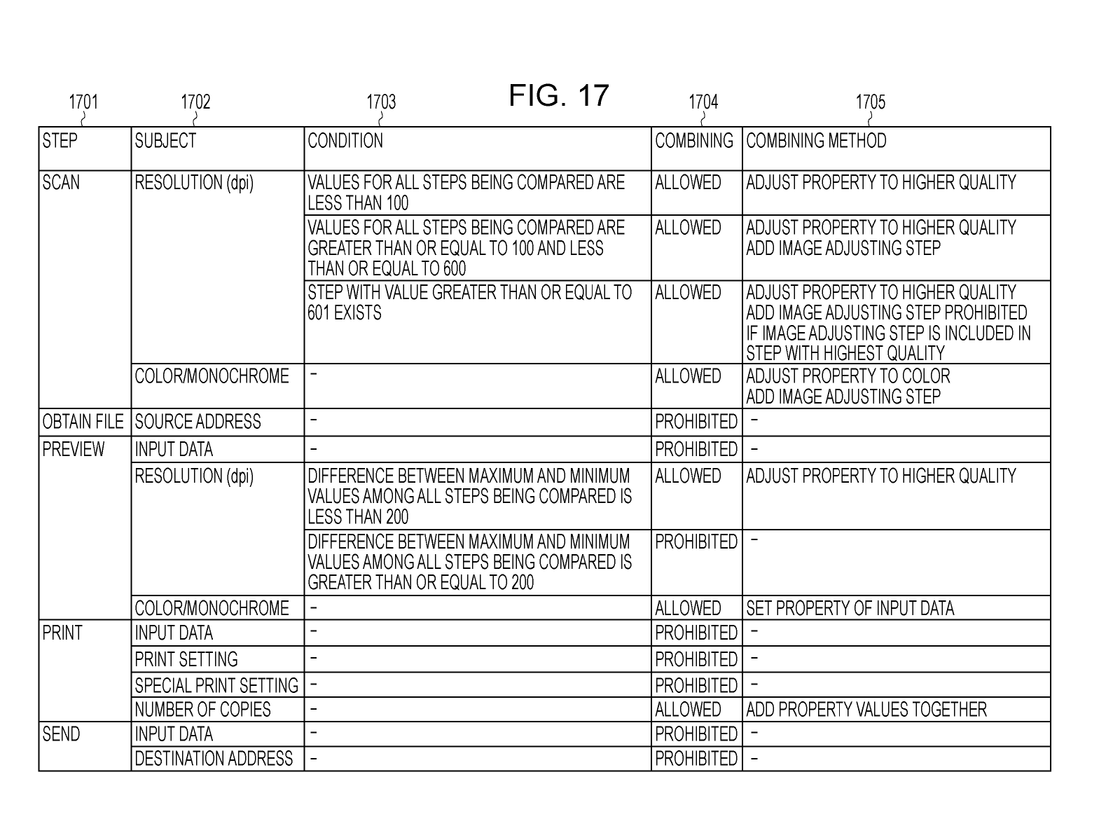

If the matching is determined as “combining prohibited” by the analyzing unit 501, the combining unit 503 refrains from combining the steps. If the properties analyzed by the analyzing unit 501 are determined as matching each other so that the matching is determined as “no difference”, the combining unit 503 combines the steps into a common step (S1506). Thus, the combining unit 503 can generate a workflow in which processing steps that use the same function are combined into a single step. The processing for generating a workflow in which processing steps that use the same function are combined into a single step is an example of processing executed by a generating unit as a feature of the present invention. Furthermore, if it is determined that combining is allowed even though the properties analyzed by the analyzing unit 501 do not match, the combining unit 503 creates a combined step according to a table shown in FIG. 17 (S1507). At this time, in some cases, additional steps are created in accordance with the combining. When steps have been combined, the original steps becomes unnecessary, so that the original steps are discarded (S1508). Steps S1506 and S1507 are examples of processing executed by a combining unit as a feature of the present invention.

Upon completion of comparison of all the steps (S1509), the joining unit 504 checks whether any combined step exists (S1510). If any combined step exists, the joining unit 504 joints the original workflows using the combined step, thereby generating a combined workflow (S1511). If no combined step exists, the joining unit 504 issues an error message indicating that it is not allowed to combine the workflows (S1512). Step S1511 is an example of processing executed by a joining unit as a feature of the present invention.

FIG. 16 is a flowchart showing details of step S1504 shown in FIG. 15. First, the analyzing unit 501 sets “no difference” as an initial value of analysis result (S1601). Then, the analyzing unit 501 compares setting values (a(m):b(m)) regarding individual properties of the two steps (A(n), B(n)), passed thereto as input parameters (S1602), and determines whether there exists any difference between the setting values (properties) of the two steps (S1603). If there exists no difference between the setting values for the two steps, the process returns to step S1602. If there exists any difference between the setting values for the two steps, the analyzing unit 501 refers to determining criterion information shown in FIG. 17 (S1604). With reference to the determining criterion information, the analyzing unit 501 determines whether it is possible to combine the steps having a difference between the setting values recognized in step S1603 (S1605). Step S1605 is an example of processing executed by a determining unit as a feature of the present invention.

If it is not possible to combine the steps, the analyzing unit 501 sets “combining prohibited” as an analysis result (S1606). The process according to the flowchart is then exited. In this case, no combined step is generated. For example, in a case of determining whether to combine previewing steps in the workflows A and B, the resolution for the previewing step in the workflow A is 600 dpi and the resolution for the previewing step in the workflow B is 200 dpi. In this case, since the difference in resolutions of the steps being compared is greater than or equal to 200, the analyzing unit 501 determines “combining prohibited” according to the table shown in FIG. 17.

On the other hand, if it is determined that the steps can be combined with reference to the determining criterion information regarding the difference between setting values recognized in step S1603, the analyzing unit 501 determines with reference to the determining criterion information whether the setting values are to be changed (S1607). If the setting values are to be changed, the setting values are stored according to a relevant combining method 1705 (S1608). For example, in a case of determining whether scanning steps in the workflows A and B are to be combined, the resolution for the scanning step in the workflow A is 600 dpi and the resolution for the scanning step in the workflow B is 400 dpi. In this case, since the difference between the resolutions for the steps being compared is greater than or equal to 100 and less than or equal to 600, the analyzing unit 501 determines that “adjust property to higher quality” according to the table shown in FIG. 17 (Yes in S1607). At this time, the analyzing unit 501 stores 500 dpi as the resolution in step S1608.

The value stored in step S1608 is used in a combined-step generating step (S1507) shown in FIG. 15 if it is determined that the steps can be combined as a result of comparing all the setting values. Through processing in step S1507, the combining unit 503 performs adjustment relating to the difference between setting values in a plurality of steps in generating a combined step.

Furthermore, in addition to changing setting values, the analyzing unit 501 determines whether any step is to be added with reference to the determining criterion information (S1609). If any step is to be added, the analyzing unit 501 specifies and stores the content of the additional step that is to be added to the combined workflow (S1610). In this step, when there exists a difference between setting values for the steps being combined, the content of an additional step for adjustment relating to the difference is specified as a processing step to be added. The stored value is used in the combined-step generating step (S1507) shown in FIG. 15 when it is determined as a result of comparing all the setting values that the steps can be combined. Processing in step S1507 is an example of processing executed by a specifying unit as a feature of the present invention. For example, in a case of determining whether the scanning steps in the workflows A and B are to be combined, the resolution for the scanning step in the workflow A is 600 dpi and the resolution for the scanning step in the workflow B is 400 dpi. In this case, since the difference between the resolutions being compared is greater than or equal to 100 and less than or equal to 600, the analyzing unit 501 determines “adjust property to higher quality” according to the table shown in FIG. 17.

Furthermore, according to the table shown in FIG. 17, the analyzing unit 501 determines that an image adjusting step is to be added (corresponding to S1609). In this case, in order to generate an image having a resolution of 400 dpi, the analyzing unit 501 specifies processing for converting an image scanned at a resolution of 600 dpi into an image having a resolution of 400 dpi as content of the image adjusting step (corresponding to S1610). As another example, in a case of combining a workflow including a step of performing color scanning at a resolution of 600 dpi and a workflow including a step of performing monochrome scanning at a resolution of 600 dpi, a combined workflow including a step of performing color scanning at a resolution of 600 dpi is generated. In this case, in order to generate a monochrome image having a resolution of 600 dpi, an image adjusting step for converting a color image into a monochrome image is added. As described above, the analyzing unit 501 adds an image adjusting step in order to generate an image that is not obtained in the combined step.

Furthermore, when a step to be added exists, the analyzing unit 501 determines whether combining of steps involving addition of an image adjusting step is allowed with reference to the table shown in FIG. 17 (S1611). If any inconsistency would arise, the analyzing unit 501 determines “combining prohibited”, and sets “combining prohibited” as an analysis result (S1606). For example, it is determined that an inconsistency would arise in a case where both flows include an image adjusting step and combining is not allowed. As another example, when a step of performing scanning in monochrome at a resolution of 1200 dpi and a step of performing scanning in color at a resolution of 600 dpi are combined, a step of performing scanning in color at a resolution of 1200 dpi is generated. In this case, in order to obtain a monochrome image having a resolution of 1200 dpi, it is necessary to convert a color image having a resolution of 1200 dpi into a monochrome image in an image adjusting step. However, the table shown in FIG. 17 says “Combining is prohibited if image adjusting step is included in step with highest quality.” That is, it is not allowed to add an image adjusting step for a monochrome scanning step with a resolution of 1200 dpi, which involves a highest quality. In such a case, the analyzing unit 501 determines that it is not allowed to combine the steps in step S1611.

If no inconsistency would arise, after adjusting properties (setting values), the analyzing unit 501 sets “Difference exists” as an analysis result (S1612). Furthermore, also in a case where it is determined in step S1602 that no additional step is to be added, the analyzing unit 501 sets “Difference exists” (S1612). Upon completion of comparison of all the setting values in the steps (S1613), the process according to the flowchart shown in FIG. 16 is exited.

FIG. 17 is a table showing determining criterion information used to determine whether combining is allowed in the process according to the flowchart shown in FIG. 16.

A step name column 1701 represents step names. A subject column 1702 represents subjects relevant to determination, i.e., setting values that are compared in the process according to the flowchart shown in FIG. 16. For example, regarding scanning steps, subjects include resolution and color/monochrome distinction. Furthermore, in the case of the second or subsequent step of each workflow (previewing step, printing step, or sending step), data input from a previous step is also considered as a subject of comparison.

A condition column 1703 represents conditions for applying associated combining methods. A combining permission/prohibition column 1704 represents whether combining is allowed. A combining method column 1705 represents combining methods that are used in cases where combining is allowed.

For example, regarding resolutions in scanning steps, if resolutions for all the steps being compared are less than 100 dpi, it is determined that an error due to the difference will be small because of the low quality, the resolutions are adjusted to a highest resolution among the steps. If resolutions for all the steps being compared are greater than or equal to 100 dpi and less than or equal to 600 dpi, a combined step that uses a highest resolution among the steps is generated, and then steps for adjusting resolutions in accordance with desired outputs of individual workflows are added.

Furthermore, if the resolution of a scanning step is greater than or equal to 601 dpi, considering the high quality, software is prohibited from readily executing an image adjusting step. For example, when a step of performing scanning in monochrome at a resolution of 1200 dpi and a step of performing scanning in color at a resolution of 600 dpi are combined, a step of performing scanning in color at a resolution of 1200 dpi is generated. In this case, in order to obtain a monochrome image having a resolution of 1200 dpi, it is necessary to convert a color image having a resolution of 1200 dpi into a monochrome image in an image adjusting step.

However, an image actually obtained by monochrome scanning at a resolution of 1200 dpi could differ from an image obtained by converting a color image with a resolution of 1200 dpi into a monochrome image by software. A user that wishes to have an image with a resolution of 1200 dpi probably wishes to have a high-quality image and will not permit even slight differences. Thus, in order to satisfy the user's demand, execution of an image adjusting step is not readily allowed in such cases described above.

In an example regarding resolutions in previewing steps, combining is not allowed if the difference between a minimum value and a maximum value among the setting values being compared is greater than or equal to 200 dpi.

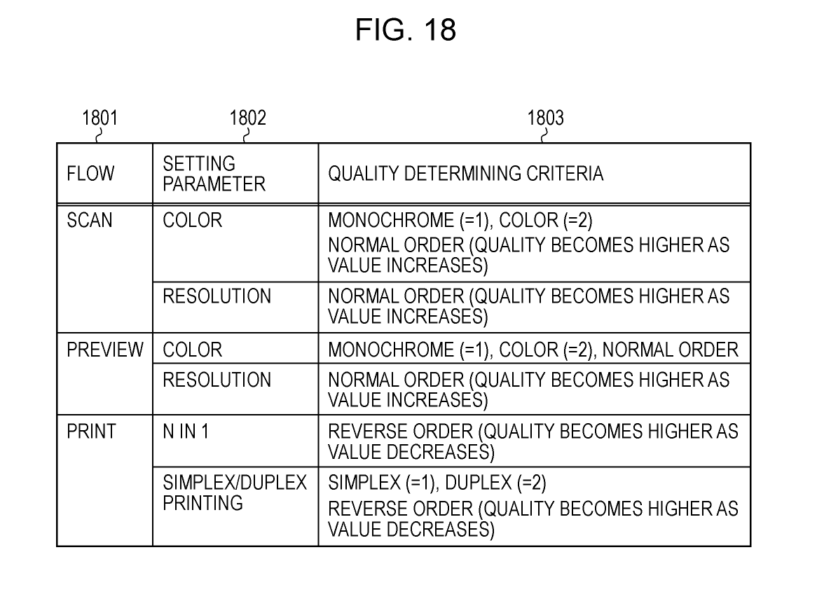

FIG. 18 is a table showing information used to determine qualities in the combining methods shown in FIG. 17.

A step name column 1801 represents step names. A setting value column 1802 represents setting values. A quality determining criterion column 1803 represents criteria for determining qualities. For example, regarding color in scanning steps, monochrome is represented by a value of “1” and color is represented by a value of “2”. It is assumed that the quality becomes higher as the value increases, i.e., color has a higher quality than monochrome. Regarding N in 1 for printing steps, it is assumed that the quality becomes higher as the value of N decreases, i.e., 1 in 1 has a higher quality than 2 in 1.

In the embodiment described above, a combined workflow is generated from two workflows. Alternatively, it is possible to combine more than two workflows. Furthermore, steps that are combined are not limited to scanning steps or previewing steps. For example, steps of obtaining files from other information processing apparatuses may be combined.

Furthermore, if an error has occurred in a processing step that depends on a workflow among a plurality of workflows, the executing unit 505 may refrain from executing a part of the combined workflow corresponding to the processing step in which the error has occurred while continuing execution of the other parts of the combined workflow composed of the other processing steps.

As described above, in the embodiment described above, when combining a plurality of workflows, it is possible to integrate steps that use the same function into a common step. Thus, the same step need not be executed a plurality of times. This improves convenience for the user. Furthermore, when steps are combined, an additional step for adjustment relating to difference between setting values between the steps is generated and added to the combined workflow as needed. Thus, the combined workflow yields a desired result of output that is to be obtained through the original workflows.

As an alternative to the embodiment described above, a storage medium storing program code of software implementing the functions of the embodiment may be supplied to a system or an apparatus so that a computer of the system or apparatus can read the program code from the storage medium and execute the program.

In this case, the program code itself, read from the storage medium, realizes the functions of the embodiment described above, so that the program code itself or the storage medium storing the program code falls within the scope of the present invention.

The storage medium for supplying the program may be, for example, a floppy disk, a hard disk, an optical disk, a magneto-optical disk, a CD-ROM, a CD-R, a magnetic tape, a non-volatile memory card, or a ROM.

Furthermore, the functions of the embodiment described above may be realized by an operating system (OS) or the like running on the computer to execute actual processing in part or in entirety according to instructions of the program code read by the computer. This also falls within the scope of the present invention.

Furthermore, the functions of the embodiment described above may be realized by writing the program code read from the storage medium to a memory in a function extension unit or the like connected to the computer so that a CPU or the like executes actual processing according to instructions of the program code. This also falls within the scope of the present invention.

Furthermore, it is possible to supply the program code to a computer via a communication medium such as the Internet. This also falls within the scope of the present invention.

While the present invention has been described with reference to exemplary embodiments, it is to be understood that the invention is not limited to the disclosed exemplary embodiments. The scope of the following claims is to be accorded the broadest interpretation so as to encompass all modifications and equivalent structures and functions.

This application claims the benefit of Japanese Application No. 2007-128165 filed May 14, 2007, which is hereby incorporated by reference herein in its entirety.

What is claimed is:

1. A workflow generating apparatus comprising:
an analyzing unit configured to analyze properties of a plurality of processing steps that are included in a plurality of workflows and that use a same function;
a combining unit configured to combine the plurality of processing steps to generate a combined processing step;
a specifying unit configured to specify an adjustment processing step if it is determined by the analyzing unit that there exists any difference among the properties of the plurality of processing steps, the adjustment processing step being a processing step for adjustment relating to the difference; and
a joining unit configured to join the plurality of workflows using the combined processing step and the adjustment processing step, thereby generating a combined workflow.

2. The workflow generating apparatus according to claim 1, wherein the combining unit performs adjustment relating to the difference among the properties of the plurality of processing steps when combining the plurality of processing steps.

3. The workflow generating apparatus according to claim 1, further comprising a determining unit configured to determine whether the combining unit is allowed to combine the plurality of processing steps based on results of analysis by the analyzing unit, wherein the combining unit refrains from combining the plurality of processing steps if it is determined by the determining unit that the combining unit is not allowed to combine the plurality of processing steps.

4. The workflow generating apparatus according to claim 1, further comprising an executing unit configured to execute the combined workflow generated by the joining unit, wherein upon occurrence of an error in a processing step that depends on one of the plurality of workflows, the executing unit continuously executes processing for a processing step that differs from the processing step in which the error has occurred and that is not affected by the processing step in which the error has occurred.

5. The workflow generating apparatus according to claim 1, further comprising an execution management unit configured to perform a control operation so that each additional step that is to be executed before or after execution of any one of the plurality of workflows is executed before or after execution of the combined workflow.

6. A workflow generating apparatus for generating a workflow in which a plurality of processing steps are executed sequentially, the workflow generating apparatus comprising:
a selecting unit configured to select a plurality of workflows;
a determining unit configured to determine processing steps that use a same function in the plurality of workflows selected by the selecting unit; and
a generating unit configured to generate a workflow in which the processing steps that use the same function, determined by the determining unit, are integrated into a single processing step.

7. A method for generating a workflow for a workflow generating apparatus, the method comprising:
analyzing properties of a plurality of processing steps that are included in a plurality of workflows and that use a same function;
combining the plurality of processing steps to generate a combined processing step;
specifying an adjustment processing step if it is determined that there exists any difference among the properties of the plurality of processing steps, the adjustment processing step being a processing step for adjustment relating to the difference; and
joining the plurality of workflows using the combined processing step and the adjustment processing step, thereby generating a combined workflow.

8. A computer-readable storage medium storing a program for causing a computer to execute a method for generating a workflow, the program comprising:
analyzing properties of a plurality of processing steps that are included in a plurality of workflows and that use a same function;
combining the plurality of processing steps to generate a combined processing step;
specifying an adjustment processing step if it is determined that there exists any difference among the properties of the plurality of processing steps, the adjustment processing step being a processing step for adjustment relating to the difference; and
a joining step of joining the plurality of workflows using the combined processing step and the adjustment processing step, thereby generating a combined workflow.

9. A method for generating a workflow for a workflow generating apparatus for generating a workflow in which a plurality of processing steps are executed sequentially, the method comprising:
selecting a plurality of workflows;
determining processing steps that use a same function in selected plurality of workflows; and
generating a workflow in which the processing steps that use the same function are integrated into a single processing step.

10. A computer-readable storage medium storing a program for causing a computer to execute a method for generating a workflow in which a plurality of processing steps are executed sequentially, the method comprising:
selecting a plurality of workflows;
determining processing steps that use a same function in selected plurality of workflows; and
generating a workflow in which the processing steps that use the same function are integrated into a single processing step.
